(19) United States
(12) Patent Application Publication
(10) Pub. No.: US 2025/0174933 A1
(43) Pub. Date: May 29, 2025

(54) DOUBLE-SEALED AND WATERPROOF CHARGING CONNECTION DEVICE AND CHARGING EQUIPMENT

(71) Applicant: Jiangsu ECONO Automotive Technology Co., Ltd., Kunshan (CN)

(72) Inventor: Feiping Liu, Kunshan (CN)

(21) Appl. No.: 19/037,224

(22) Filed: Jan. 26, 2025

(30) Foreign Application Priority Data
Dec. 5, 2024 (CN) 202411784300.3

(51) Int. Cl. H01R 13/52; B60L 53/14

(52) U.S. Cl. CPC H01R 13/5227; H01R 13/5202; B60L 53/14

(57) ABSTRACT

A double-sealed and waterproof charging connection device is provided, including: a charging socket, including a socket housing for allowing a charging connector to be inserted and removed, and a charging port arranged in the socket housing and configured to be electrically connected to the charging connector, wherein a locking hole is provided in a lower part of the socket housing close to the charging port; a water tank, arranged below the socket housing, wherein the water tank includes a water tank housing and a sealing tube arranged in the water tank housing; the water tank housing is hermetically connected to the socket housing and surrounds the locking hole; a hole corresponding to the locking hole is arranged below the water tank housing; a lower end of the sealing tube is hermetically connected to the water tank housing around the through hole.

### TECHNICAL FIELD

The present disclosure relates to the technical field of charging of new energy vehicles, and more particularly, to a double-sealed and waterproof charging connection device and charging equipment including the charging connection device.

### BACKGROUND

With the rapid development of the times and the improvement of the living standard, vehicles are gradually popular. In the current vehicle market, new energy vehicles account for a considerable proportion. With the development of vehicle intelligence, more and more people take new energy vehicles as their first choices.

The new energy vehicles mainly include electric vehicles and hybrid vehicles. All the electric vehicles and most of the hybrid vehicles have charging ports, and the new energy vehicles are charged by being connected to a charging connection device through the charging ports, thus meeting a further usage need.

The charging connection device is an essential device for charging a new energy vehicle. Some of the existing charging connection devices are arranged in an outdoor parking environment. Waterproofing for a charging connection in a charging process is an important technology topic. The adverse effect of waterproofing can cause equipment damage or a safety accident. A waterproof structure of the charging port of the charging connection device has a problem of a complex structure, a poor waterproof effect, etc., which cannot well meet needs of users.

### SUMMARY

In view of the above content, the present disclosure aims to at least solve one of the technical problems in the prior art. To this end, the present disclosure provides a double-sealed and waterproof charging connection device and charging equipment. Based on a structure in which a locking actuator is arranged below a charging socket, a water tank including a scaling tube is provided. The sealing tube is hermetically connected to the bottom of the water tank housing and is hermetically connected to the locking pin respectively, thus draining water that possibly enters the socket housing and avoiding the water from entering other regions of the locking actuator to cause damage to the equipment. Meanwhile, the charging connection device has a simple structure and is suitable for being applied to mass production.

To this end, in a first aspect, an embodiment of the present disclosure provides a double-sealed and waterproof charging connection device, including:
a charging socket, including a socket housing for allowing a charging connector to be inserted and removed, and a charging port arranged in the socket housing and configured to be electrically connected to the charging connector, wherein a locking hole is provided in a lower position of the socket housing close to the charging port;
a water tank, arranged below the socket housing, wherein the water tank includes a water tank housing and a sealing tube arranged in the water tank housing; the water tank housing is hermetically connected to the socket housing and surrounds the locking hole; a through hole corresponding to the locking hole is arranged below the water tank housing; a lower end of the sealing tube is hermetically connected to the water tank housing around the through hole; and
a locking actuator, arranged below the water tank housing, wherein the locking actuator includes a lock housing and a locking pin which moving up and down relative to the lock housing; the locking pin passes through the through hole, the sealing tube, and the locking hole in sequence and enters the socket housing; and the locking pin is hermetically connected to an upper area of the sealing tube.

Preferably, the sealing tube is configured as a retractable structure.

Preferably, the sealing tube is configured as a corrugated tube; or,
the sealing tube is configured as a rubber tube or a silicone tube.

Preferably, a peripheral edge of the lower end of the sealing tube is folded outward to form a scaling rib, and a first sealing slot which surrounds the through hole and is configured to correspondingly accommodate the sealing rib is provided in a bottom of the water tank housing.

Preferably, a connection ring surrounding the through hole is arranged at the bottom of the water tank housing. The connection ring is spaced apart from the bottom of the water tank housing to form the first sealing slot. The first sealing slot fixes the sealing tube by welding or clamping.

Preferably, a peripheral edge of an upper end of the sealing tube extends inward to form a sealing hoop; and the locking pin is provided with a second sealing slot for correspondingly and hermetically accommodating the sealing hoop.

Preferably, the water tank further includes a drainage tube; the drainage tube is connected to the outside by the bottom of the water tank housing; and/or,
a sealing gasket is arranged between the water tank housing and a connection structure of the socket housing.

Preferably, the locking actuator is configured to drive the locking pin to move.

Preferably, a peripheral edge of the lower end of the sealing tube is folded outward to form a sealing rib, and a first sealing slot which surrounds the through hole and is configured to correspondingly accommodate the sealing rib is provided in a bottom of the water tank housing. A peripheral edge of an upper end of the sealing tube extends inward to form a sealing hoop. The locking pin is provided with a second sealing slot for correspondingly and hermetically accommodating the sealing hoop. The upper end of the sealing tube is hermetically connected to the locking pin. The lower end of the sealing tube is hermetically connected to the bottom of the water tank housing.

In a second aspect, an embodiment of the present disclosure further provides charging equipment, including the charging connection device in the first aspect, and a power supply device electrically connected to the charging port.

According to the double-sealed and waterproof charging connection device and the charging equipment, based on a structure in which a locking actuator is arranged below a charging socket, a water tank including a sealing tube is provided between the charging socket and the locking actuator. The sealing tube is hermetically connected to the bottom of the water tank housing and is hermetically connected to the locking pin respectively, so that the water tank is in single communication into the socket housing, thus draining water that possibly enters the socket housing and avoiding the water from entering other regions of the charging connection device, such as a circuit module inside the locking actuator. Thus, damage to the equipment is avoided. The charging connection device has a simple structure and a good waterproof effect, so that a good use experience is provided for a user.

### BRIEF DESCRIPTION OF THE DRAWINGS

FIG. 1 is a schematic diagram of a three-dimensional structure of a double-sealed and waterproof charging connection device according to an embodiment of the present disclosure;

FIG. 2 is a schematic diagram of a three-dimensional structure of omitting some elements of the charging connection device in FIG. 1;

FIG. 3 is an exploded structural diagram of a charging connection device in FIG. 1;

FIG. 4 is a cross-sectional structural diagram of the charging connection device in FIG. 1 along line A-A;

FIG. 5 is an enlarged view of region B in FIG. 4; and

FIG. 6 is a side view of the charging connection device in FIG. 2.

### DETAILED DESCRIPTION OF THE EMBODIMENTS

Detail description of the embodiments of present disclosure will be made in the following, and examples thereof are illustrated in the drawings, throughout which identical or similar elements or elements of identical or similar functions are represented with identical or similar reference numerals. The embodiments that are described with reference to the accompanying drawings are exemplary, and are only used to interpret the present disclosure, instead limiting the present disclosure.

The following disclosure provides many different embodiments or examples to implement different structures of the present disclosure. To simplify the disclosure of the present disclosure, components and settings of specific examples are described below. Of course, they are merely examples and are not intended to limit the present disclosure. In addition, the present disclosure may repeatedly refer to numbers and/or letters in different examples. Such repetition is for purposes of simplicity and clarity and does not itself indicate a relationship between the various embodiments and/or settings discussed. In addition, the present disclosure provides examples of various specific processes and materials, but a person of ordinary skill in the art will recognize the application of other processes and/or the use of other materials.

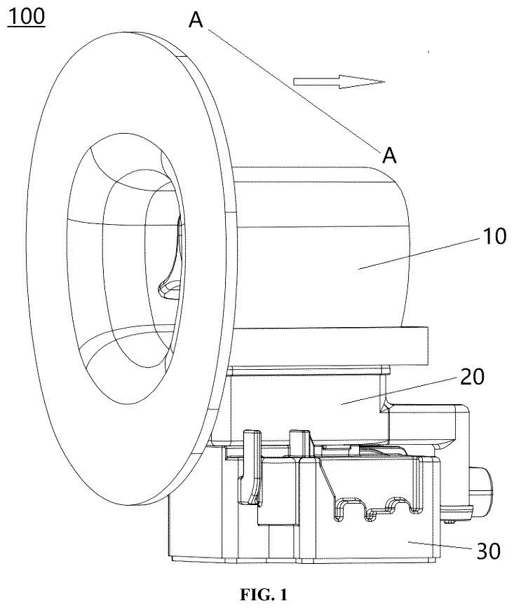

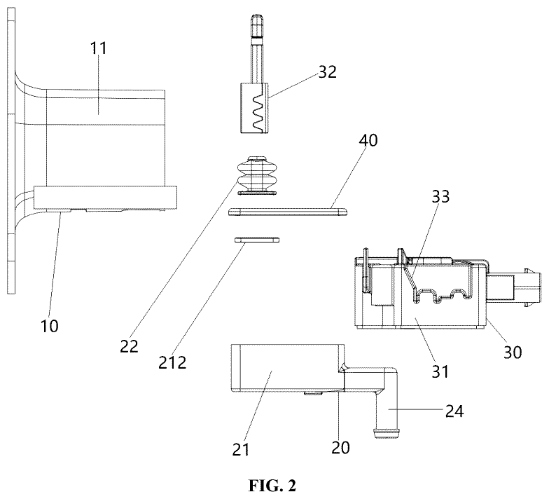

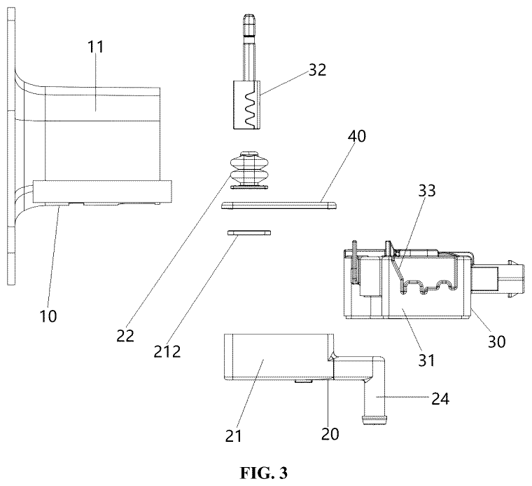

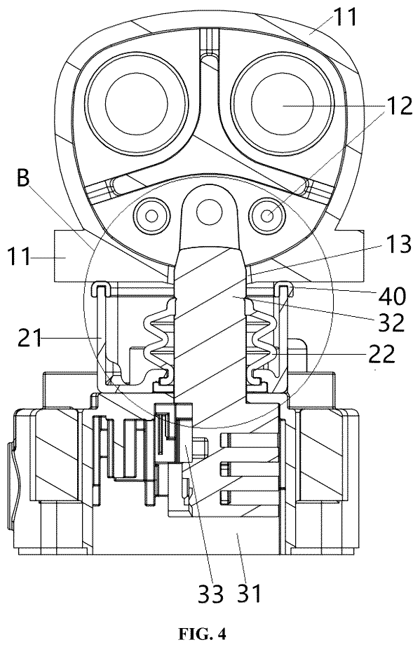

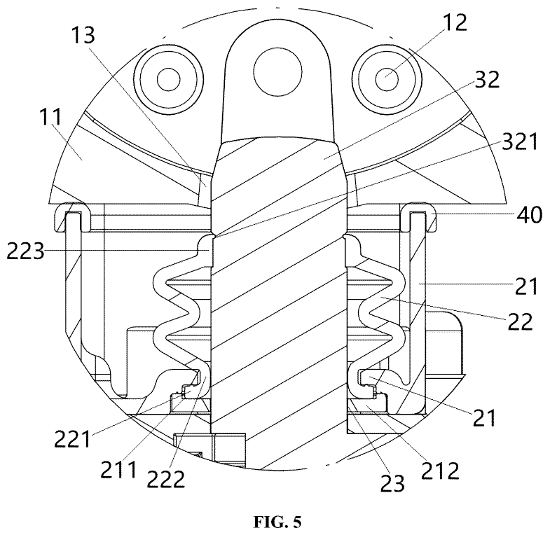

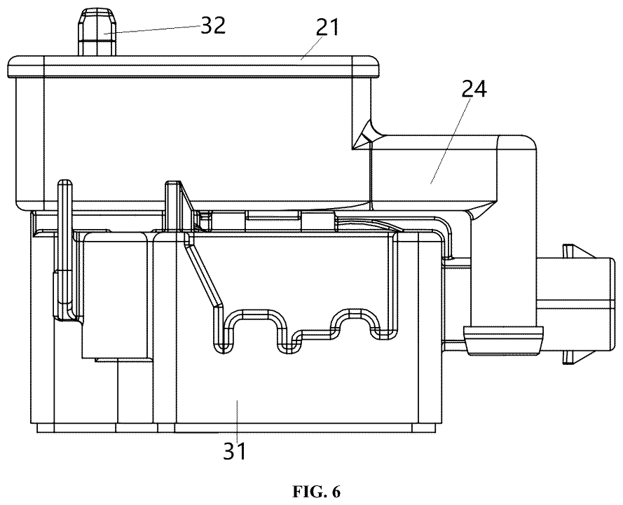

Referring to FIG. 1 to FIG. 6, the present disclosure aims to provide a double-sealed and waterproof charging connection device 100. In charging equipment, the charging equipment can be charging equipment of a public charging service station or personal charging equipment at a private parking space, or can be a vehicle body charging port. The charging connection device 100 is configured to achieve connection between the charging equipment and a charging connector of a new energy vehicle, to charge the new energy vehicle.

The charging connection device 100 includes:
a charging socket 10, including a socket housing 11 for allowing a charging connector to be inserted and removed, and a charging port 12 arranged in the socket housing 11 and configured to be electrically connected to the charging connector, wherein a locking hole 13 is provided in a lower part of the socket housing 11 close to the charging port 12;
a water tank 20, arranged below the socket housing 11, wherein the water tank 20 includes a water tank housing 21 and a sealing tube 22 arranged in the water tank housing 21; the water tank housing 21 is hermetically connected to the socket housing 11 and surrounds the locking hole 13; a through hole 23 corresponding to the locking hole 13 is arranged below the water tank housing 21; a lower end of the sealing tube 22 is hermetically connected to the water tank housing 21 around the through hole 23; and
a locking actuator 30, arranged below the water tank housing 21, wherein the locking actuator 30 includes a lock housing 31 and a locking pin 32 capable of moving up and down relative to the lock housing 31; the locking pin 32 can pass through the through hole 23, the sealing tube 22, and the locking hole 13 in sequence and enter the socket housing 11; and the locking pin 32 is hermetically connected to an upper end of the sealing tube 22.

In this embodiment, the locking actuator 30 is arranged below the charging socket 10, and the locking pin 32 of the locking actuator can move into the socket housing 11. This structure meets the North American charging standard (NACS). Further, the water tank 20 is arranged between the locking actuator 30 and the charging socket 10, and the locking pin 32 is configured to pass through the water tank 20. Meanwhile, the water tank 20 is provided with a sealing structure that can receive water droplets or water that may occur in the socket housing 11 of the charging socket 10, without allowing the water droplets or water to enter a region where the locking actuator 30 is located. The structure is simple and stable, and a good waterproof effect is achieved.

Further, the sealing tube 22 is configured as a retractable structure. In this embodiment, the sealing tube 22 is configured as the retractable structure. The lower end of the sealing tube 22 is hermetically connected to the water tank housing 21, and an upper end of the sealing tube 22 is hermetically connected to the locking pin 32. The retractable structure of the sealing tube 22 allows the locking pin 32 to always maintain a relative sealed state with the water tank 20 during its up and down movement. It can be understood that the sealing tube 22 may not be of the retractable structure. The upper end of the sealing tube 22 slides relative to the locking pin 32 to maintain sealing, which can prevent the water droplets or water from passing through.

Further, the sealing tube 22 is configured as a corrugated tube. In this embodiment, the sealing tube 22 is configured as the corrugated tube structure, which has a good retractable structure and can maintain the structural stability even after long-term expansion and retraction.

It can be understood that the sealing tube 22 can be further configured as a rubber tube or a silica gel tube. The sealing tube 22 is elastic, which can achieve expansion and retraction, to also meet a relevant waterproof requirement.

Further, a peripheral edge of the lower end of the sealing tube 22 is folded outward to form a sealing rib 221, and a first sealing slot 211 which surrounds the through hole 23 and is configured to correspondingly accommodate the sealing rib 221 is provided in a bottom of the water tank housing 21. In this embodiment, by the arrangement of a cooperation structure for the sealing rib 221 and the first sealing slot 211, a hermetical connection structure for the sealing tube 22 and the water tank housing 21 is strengthened, which can further enhance the waterproof effect.

Specifically, a connection ring 212 surrounding the through hole 23 is arranged at the bottom of the water tank housing 21; the connection ring 212 is spaced apart from the bottom of the water tank housing 21 to form the first sealing slot 211; and the first sealing slot 211 fixes the sealing tube 22 by welding or clamping. It can be understood that the water tank housing 21 and the connection ring 212 can be further integrally formed, as long as corresponding hermetical connection is formed between the first sealing slot 211 and the sealing rib 221.

Further, a sealing ring 222 hermetically connected to the locking pin 32 is formed at a peripheral edge of the sealing tube 22 close to the lower end. In this embodiment, a hermetical connection is added between the lower end of the sealing tube 22 and the locking pin 32, which further enhances the sealing effect of the overall structure. The hermetical connection here is a sliding friction hermetical connection.

Further, a peripheral edge of an upper end of the sealing tube 22 extends inward to form a sealing hoop 223; and the locking pin 32 is provided with a second sealing slot 321 for correspondingly and hermetically accommodating the sealing hoop 223. In this embodiment, the upper end of the sealing tube 22 is configured to prevent the water droplets or water from flowing along a wall surface of the locking pin 32. A cooperation structure for the sealing hoop 223 and the second sealing slot 321 further prevents the water droplets or water and can further improve the structural stabilities of the sealing tube 22 and the locking pin 32.

Further, the water tank 20 further includes a drainage tube 24; and the drainage tube 24 is communicated to the outside by the bottom of the water tank housing 21. In this embodiment, the water tank 20 discharges water inside the water tank housing 21 to the outside through the drainage tube 24, to avoid water accumulation.

Further, a sealing gasket 40 is arranged between the water tank housing 21 and a connection structure of the socket housing 11. The sealing gasket 40 is specifically configured as a specially-shaped sealing gasket to adapt to an interface shape of the water tank housing 21 and a connection portion of the socket housing 11.

Further, the locking actuator 30 further includes a driver 33; and the driver 33 is arranged inside the lock housing 31 and configured to drive the locking pin 32 to move.

In an embodiment, a peripheral edge of the lower end of the sealing tube 22 is folded outward to form a sealing rib 221, and a first sealing slot 211 which surrounds the through hole 23 and is configured to correspondingly accommodate the sealing rib 221 is provided in a bottom of the water tank housing 21; a peripheral edge of an upper end of the sealing tube 22 extends inward to form a sealing hoop 223; the locking pin 32 is provided with a second sealing slot 321 for correspondingly and hermetically accommodating the sealing hoop 223; the upper end of the sealing tube 22 is hermetically connected to the locking pin 32; and the lower end of the sealing tube 22 is hermetically connected to the bottom of the water tank housing 21. In this embodiment, by the arrangement of the sealing tube 22, the upper end and lower end of the sealing tube 22 are hermetically connected to the locking pin 32 and the water tank housing 21 respectively, so that sealing of the charging socket 10 and the locking actuator 30 is achieved.

In a second aspect, an embodiment of the present disclosure further provides charging equipment, including the above charging connection device, and a power supply device electrically connected to the charging port. The power supply device is connected to a mains supply or industrial electricity, and electrical energy is output to the new energy vehicle through the charging connection device and a charging connector.

In the description of this specification, the description referring to the terms “one embodiment”, “some embodiments”, “an example”, “specific examples”, “some examples”, or the like means that specific features, structures, materials or characteristics described in connection with the embodiments or examples are included in at least one embodiment or example of the present disclosure. In this specification, the schematic representations of the above terms are not necessarily intended to refer to the same embodiment or example. Furthermore, the specific features, structures, materials or characteristics described may be combined in any suitable manner in any one or more embodiments or examples. In addition, those skilled in the art may combine the different embodiments or examples described in this specification, as well as the features of different embodiments or examples, without mutual contradictions.

Although the embodiments of the present disclosure have been shown and described, it can be understood by those of ordinary skill in the art that various changes, modifications, substitutions variations can be made to these embodiments without departing from the principle and concept of the present disclosure. The scope of the present disclosure is defined by the claims and their equivalents.

What is claimed is:

1. A double-sealed and waterproof charging connection device, comprising:
a charging socket, comprising a socket housing for allowing a charging connector to be inserted and removed, and a charging port arranged in the socket housing and configured to be electrically connected to the charging connector, wherein a locking hole is provided in a lower part of the socket housing close to the charging port;
a water tank, arranged below the socket housing, wherein the water tank comprises a water tank housing and a sealing tube arranged in the water tank housing; the water tank housing is hermetically connected to the socket housing and surrounds the locking hole; a through hole corresponding to the locking hole is arranged below the water tank housing; a lower end of the sealing tube is hermetically connected to the water tank housing around the through hole; and
a locking actuator, arranged below the water tank housing, wherein the locking actuator comprises a lock housing and a locking pin capable of moving up and down relative to the lock housing; the locking pin passes through the through hole, the sealing tube, and the locking hole in sequence and enters the socket housing; and the locking pin is hermetically connected to an upper end of the sealing tube.

2. The charging connection device according to claim 1, wherein the sealing tube is configured as a retractable structure.

3. The charging connection device according to claim 2, wherein the sealing tube is configured as a corrugated tube; or,
the sealing tube is configured as a rubber tube or a silica gel tube.

4. The charging connection device according to claim 1, wherein a peripheral edge of the lower end of the sealing tube is folded outward to form a sealing rib, and a first sealing slot which surrounds the through hole and is configured to correspondingly accommodate the sealing rib is provided in a bottom of the water tank housing.

5. The charging connection device according to claim 4, wherein a connection ring surrounding the through hole is arranged at the bottom of the water tank housing; the connection ring is spaced apart from the bottom of the water tank housing to form the first sealing slot; and the first sealing slot fixes the sealing tube by welding or clamping.

6. The charging connection device according to claim 1, wherein a peripheral edge of an upper end of the sealing tube extends inward to form a sealing hoop; and the locking pin is provided with a second sealing slot for correspondingly and hermetically accommodating the sealing hoop.

7. The charging connection device according to claim 1, wherein the water tank further comprises a drainage tube; the drainage tube is communicated to the outside by the bottom of the water tank housing; and/or,
a sealing gasket is arranged between the water tank housing and a connection structure of the socket housing.

8. The charging connection device according to claim 1, wherein the locking actuator further comprises a driver; and the driver is arranged inside the lock housing and configured to drive the locking pin to move.

9. The charging connection device according to claim 1, wherein a peripheral edge of the lower end of the sealing tube is folded outward to form a sealing rib, and a first sealing slot which surrounds the through hole and is configured to correspondingly accommodate the sealing rib is provided in a bottom of the water tank housing; a peripheral edge of an upper end of the sealing tube extends inward to form a sealing hoop; the locking pin is provided with a second sealing slot for correspondingly and hermetically accommodating the sealing hoop; the upper end of the sealing tube is hermetically connected to the locking pin; and the lower end of the sealing tube is hermetically connected to the bottom of the water tank housing.

10. Charging equipment, comprising the charging connection device according to claim 1 and a power supply device electrically connected to the charging port.

11. Charging equipment, comprising the charging connection device according to claim 2 and a power supply device electrically connected to the charging port.

12. Charging equipment, comprising the charging connection device according to claim 3 and a power supply device electrically connected to the charging port.

13. Charging equipment, comprising the charging connection device according to claim 4 and a power supply device electrically connected to the charging port.

14. Charging equipment, comprising the charging connection device according to claim 5 and a power supply device electrically connected to the charging port.

15. Charging equipment, comprising the charging connection device according to claim 6 and a power supply device electrically connected to the charging port.

16. Charging equipment, comprising the charging connection device according to claim 7 and a power supply device electrically connected to the charging port.

17. Charging equipment, comprising the charging connection device according to claim 8 and a power supply device electrically connected to the charging port.

18. Charging equipment, comprising the charging connection device according to claim 9 and a power supply device electrically connected to the charging port.
